(19) United States
(12) Patent Application Publication
(10) Pub. No.: US 2013/0231237 A1
(43) Pub. Date: Sep. 5, 2013

(54) OPTICAL GLASS, PREFORM FOR PRECISION PRESS MOLDING AND OPTICAL ELEMENT USING THE SAME

(71) Applicant: ASAHI GLASS COMPANY, LIMITED, Chiyoda-ku (JP)

(72) Inventor: Noriyoshi KAYABA, Tokyo (JP)

(73) Assignee: ASAHI GLASS COMPANY, LIMITED, Chiyoda-ku (JP)

(21) Appl. No.: 13/780,570

(22) Filed: Feb. 28, 2013

(30) Foreign Application Priority Data
Mar. 1, 2012 (JP) 2012-045362

(51) Int. Cl. C03C 3/068

(52) U.S. Cl. CPC C03C 3/068
USPC 501/78

(57) ABSTRACT

The present invention relates to an optical glass containing, in terms of % by weight on the basis of oxides, B₂O₃: 8 to 15%, La₂O₃: 27 to 40%, SiO₂: 1 to 10%, ZnO: 13 to 20%, WO₃: 9 to 17%, Ta₂O₅: 7 to 15%, ZrO₂: 1 to 6%, Y₂O₃: 2 to 8%, and Bi₂O₃: 0 to 5%, in which the optical glass contains substantially no Li₂O and Gd₂O₃, and the optical glass has a refractive index n_{d} of 1.86 to 1.90 and an Abbe number v_{d} of 35 to 40.

### TECHNICAL FIELD

The present invention relates to an optical glass having optical properties of high refractive index and low dispersion property, and a preform for precision press molding using the optical glass and an optical element using the preform.

### BACKGROUND ART

Since highly precise and compact digital cameras, camera-equipped mobile-phones and the like have been popularized, demands for weight saving and miniaturization of optical systems to be used therein have been rapidly increased. In the optical systems, an optical glass having optical properties of high refractive index and low dispersion property has been used. Also, it is the mainstream that such optical glasses are manufactured by precision press molding (hereinafter simply abbreviated as press molding) which is high in production efficiency.

Currently, as an optical glass having optical properties of high refractive index and low dispersion property, glass containing B₂O₃ and La₂O₃ as main components has been widely used. For the purpose of forming an optical glass suitable for press molding, there has been adopted a method for enhancing productivity by, using B₂O₃-La₂O₃ system as a base, incorporating thereto a component that lowers glass transition temperature or a component that increases viscosity of a glass molten liquid. Also, as a method for obtaining an optical glass having desired optical constants, especially higher refractive index, it is proposed to incorporate a high refractive index-imparting component such as an oxide of a rare-earth element.

Hitherto, in the B₂O₃-La₂O₃-type optical glass, the glass transition temperature has been lowered by incorporating an alkali metal oxide, especially Li₂O. However, Li₂O is a component that is prone to be volatilized as compared with other components of the glass composition and, when the component is volatilized upon melting the glass composition, there is a concern that the composition of the glass molten liquid becomes heterogeneous. Also, when press molding is performed using glass containing Li₂O, a white cloudy altered layer called haze or dimming tends to be generated on the glass surface of a press-molded article. When the altered layer is present on the lens surface, the article is regarded as a defective one and therefore the haze or dimming should be removed by polishing, so that the productivity rather decreases.

Patent Document 1 proposes an optical glass having glass transition temperature of 625° C. or lower whose glass surface is not altered upon press molding, the optical glass being obtained by controlling the composition of the optical glass as follows: B₂O₃ is 20 to 60% by mol; La₂O₃ is 5 to 24% by mol and Gd₂O₃ is 0 to 20% by mol, provided that total content of La₂O₃ and Gd₂O₃ is 10 to 24% by mol; ZnO is 22 to 42% by mol; and Li₂O is not substantially contained.

However, since the presence of high refractive index-imparting components is not sufficient in the optical glass, high refractive index is not achieved.

Patent Document 2 proposes an optical glass having optical constants of refractive index of 1.8 to 2.1 and Abbe number of 20 to 40, the optical glass being obtained by controlling the composition of the optical glass as follows: B₂O₃ is 2 to 45% by mass; La₂O₃ is 10 to 50% by mass; Gd₂O₃ is 0 to 20% by mass, ZnO is 0 to 15 by mass; and Na₂O, K₂O and Li₂O are 0% by mass or more to less than 1.5% by mass in total. Also, in Examples, glasses which do not contain Li₂O and Gd₂O₃ are described.

In the glasses in the above Examples, the content of ZnO that is a component which lowers the glass transition temperature is 7.21% by mass at the maximum and thus is not sufficient. Therefore, molding temperature upon press molding becomes high, which is not preferred from the viewpoint of improving productivity of the whole process.

Patent Document 3 proposes an optical glass having glass transition temperature of 655° C. or lower and refractive index of 1.85 to 1.93, the optical glass being obtained by controlling the composition of the optical glass as follows: B₂O₃ is 5 to 45% by mol; ZnO is 10 to 40% by mol; La₂O₃ is 5 to 30% by mol; Gd₂O₃ is 0 to 20% by mol; at least one of TiO₂, Nb₂O₅, WO₃, and Bi₂O₃ is contained and total content of Ti, Nb, W, and Bi in terms of cation % is 3 to 25%; and Li₂O is 0 to 3% by mol.

However, since the optical glass contains Gd₂O₃ as a high refractive index-imparting component, the viscosity of the glass molten liquid does not sufficiently increase and a preform for press molding cannot be stably manufactured. Thereby, the productivity of the whole production process is decreased.

Patent Document 1: JP-A-2009-91242

Patent Document 2: JP-A-2010-215503

Patent Document 3: WO2009/144947

### SUMMARY OF THE INVENTION

In order to solve the above problems, an object of the present invention is to provide an optical glass having optical properties of high refractive index and low dispersion property, which has low press molding temperature and is less prone to generate defects upon press molding, and whose glass molten liquid at liquidus temperature has high viscosity.

The present inventors have found that an optical glass which has desired optical constants and low press molding temperature and whose glass molten liquid has viscosity suitable for preform molding, can be achieved by using a glass composition containing a B₂O₃-La₂O₃-type glass composition as a base, containing substantially no Li₂O and Gd₂O₃, containing Y₂O₃ as a component that imparts high refractive index and increases the viscosity of the glass molten liquid, and containing ZnO as a component that lowers the glass transition temperature. Thus, they have accomplished the present invention.

Namely, the present invention provides an optical glass containing, in terms of % by weight on the basis of oxides, B₂O₃: 8 to 15%, La₂O₃: 27 to 40%, SiO₂: 1 to 10%, ZnO: 13 to 20%, WO₃: 9 to 17%, Ta₂O₅: 7 to 15%, ZrO₂: 1 to 6%, Y₂O₃: 2 to 8%, and Bi₂O₃: 0 to 5%, in which the optical glass contains substantially no Li₂O and Gd₂O₃, and in which the optical glass has a refractive index n_{d} of 1.86 to 1.90 and an Abbe number v_{d} of 35 to 40.

The optical glass of the present invention (hereinafter referred to as present glass) has optical constants of refractive index n_{d} with respect to d line (587.6 nm) of 1.86 to 1.90 and Abbe number v_{d} of 35 to 40.

Since the present glass contains substantially no Li₂O, composition of the glass molten liquid can be prevented from becoming inhomogeneous due to volatilization of the component and the surface of a press-molded article can be prevented from being altered upon press molding. Also, when the present glass is subjected to press molding, an optical element in which no altered layer is generated on the surface thereof can be obtained.

Since the present glass contains Y₂O₃ as an essential component that is a high-refractive-index and low-dispersion component, and contains substantially no Gd₂O₃ that is also a high-refractive-index and low-dispersion component but has a low effect of increasing viscosity of the glass molten liquid, the glass has high refractive index and the viscosity of the glass molten liquid becomes high. Therefore, the present glass is suitable for preform production.

The present glass can suppress the liquidus temperature T_{L} to 1,130° C. or lower by optimizing the content and ratio of the oxides of rare-earth elements. When the liquidus temperature T_{L} falls within this range, it is preferred because such glass is excellent in devitrification resistance upon preform molding and whose glass molten liquid has high viscosity, so that the glass can provide a preform having even shape and weight.

### DETAILED DESCRIPTION OF THE INVENTION

The reasons for setting the ranges of the respective components of the present glass will be described below. In the present specification, hereinafter, % means % by weight unless otherwise stated. Also, the chemical composition is represented on the basis of oxides.

In the present glass, B₂O₃ is a component which forms a glass network and lowers the liquidus temperature, and is an essential component. In the present glass, the content of B₂O₃ is set to 8 to 15%. When the content of B₂O₃ is less than 8%, vitrification becomes difficult, which is hence not preferred. By controlling the content of B₂O₃ to 8% or more, a glass having an excellent devitrification resistance can be obtained. The glass having the content of B₂O₃ of 9% or more is more preferred. When the content of B₂O₃ is 10.5% or more, the liquidus temperature decreases and also Abbe number can be increased, which is hence further preferred.

On the other hand, in the present glass, when the content of B₂O₃ exceeds 15%, there is a concern that refractive index decreases and chemical durability such as water resistance deteriorates. Therefore, in the present glass, the content of B₂O₃ is 15% or less. In the case where it is intended to increase the refractive index, the content of B₂O₃ is preferably set to 14% or less, and the content of B₂O₃ is further preferably 13% or less.

In the present glass, La₂O₃ is a component which increases the refractive index, increases the Abbe number, and improves the chemical durability, and is an essential component. In the present glass, the content of La₂O₃ is set to 27 to 40%. When the content of La₂O₃ is less than 27%, there is a concern that the refractive index decreases. The content of La₂O₃ is preferably 30.5% or more and further preferably 34% or more.

On the other hand, when the content of La₂O₃ exceeds 40%, vitrification tends to be difficult and there is a concern that the glass molding temperature increases and the liquidus temperature increases. The content of La₂O₃ is preferably 39% or less and more preferably 38% or less.

In the present glass, SiO₂ is a component which stabilizes the glass and suppresses devitrification effectively upon glass molding from the molten liquid (hereinafter referred to as upon glass molding), and is an essential component. In the present glass, the content of SiO₂ is set to 1 to 10%. When the content of SiO₂ exceeds 10%, the glass transition temperature increases, so that there is a concern that the press molding temperature increases and the refractive index becomes too low. The content of SiO₂ is preferably 7.5% or less and more preferably 5% or less.

On the other hand, by controlling the content of SiO₂ to 1% or more, the devitrification upon glass molding can be suppressed and the viscosity of the glass molten liquid can be adjusted. The content of SiO₂ is preferably 1.5% or more and the glass having the content of SiO₂ exceeding 2% is more preferred.

In the present glass, ZnO is a component which stabilizes the glass and lowers the press molding temperature and the melting temperature, and is an essential component. In the present glass, the content of ZnO is set to 13 to 20%. Since the present glass contains substantially no Li₂O as mentioned above, there is a concern that the press molding temperature increases when the content of ZnO is less than 13%. The content of ZnO preferably exceeds 15% and the content of ZnO is further preferably 15.3% or more. On the other hand, in the present glass, when the content of ZnO exceeds 20%, the stability of the glass becomes worse and there is a concern that the chemical durability also deteriorates. The content of ZnO is preferably 19.5% or less and the content of ZnO is further preferably 19% or less.

In the present glass, WO₃ is a component which stabilizes the glass, increases the refractive index, and suppresses devitrification effectively upon glass molding, and is an essential component. In the present glass, the content of WO₃ is set to 9 to 17%. When the content of WO₃ is less than 9%, the refractive index decreases and there is a concern that the liquidus temperature increases. The content of WO₃ is preferably 10% or more and the content of WO₃ is more preferably 11% or more.

On the other hand, when the content of WO₃ exceeds 17%, the refractive index increases but the Abbe number becomes small, so that the desired low dispersion property cannot be obtained. Therefore, the content of WO₃ is preferably 16% or less and the content of WO₃ is further preferably 15.5% or less.

In the present glass, Ta₂O₅ is a component which stabilizes the glass, increases the refractive index, and suppresses devitrification upon glass molding, and is an essential component. In the present glass, the content of Ta₂O₅ is set to 7 to 15%. When the content of Ta₂O₅ is less than 7%, the refractive index decreases and there is a concern that the liquidus temperature increases. The content of Ta₂O₅ is preferably 8% or more and more preferably 8.5% or more.

On the other hand, when the content of Ta₂O₅ is too large, the glass melting temperature becomes high and the specific gravity increases. Further, when the content of Ta₂O₅ is too large, crystals containing Ta (e.g., LaTaO₇, LiTa₃O₇) are prone to precipitate at the liquidus temperature or lower and, since Ta is a rare element and is an expensive component, the case results in an increase of production costs. In the present glass, the content of Ta₂O₅ is 15% or less. The content of Ta₂O₅ is preferably 13.5% or less and further preferably 12% or less.

In the present glass, ZrO₂ is a component which stabilizes the glass, increases the refractive index, and leads suppression of the devitrification upon glass molding, and is an essential component. In the present glass, the content of ZrO₂ is set to 1 to 6%. When the content of ZrO₂ exceeds 6%, the press molding temperature becomes high, and the refractive index increases but the Abbe number becomes small. Also, when the content of ZrO₂ exceeds 6%, ZrO₂ is prone to precipitate at the liquidus temperature or lower, the glass is not stabilized, and also, there is a concern that the liquidus temperature increases. The content of ZrO₂ is more preferably 4.5% or less, the content of ZrO₂ is further preferably 3.5% or less, and the content of ZrO₂ is particularly preferably 3.2% or less.

On the other hand, in order to obtain an effect due to the addition of ZrO₂, the content of ZrO₂ is preferably 1.5% or more and the content of ZrO₂ is further preferably 2% or more.

In the present glass, Y₂O₃ is, as in the case of La₂O₃, a component which increases the refractive index, increases the Abbe number and improves the chemical durability, and is an essential component. Furthermore, Y₂O₃ is also a component which stabilizes the glass, and increases the viscosity of glass molten liquid more effectively as compared with oxides of other rare-earth elements. In the present glass, the content of Y₂O₃ is set to 2 to 8%. The content of Y₂O₃ is preferably 3% or more and the content of Y₂O₃ is further preferably 3.5% or more.

On the other hand, when the content of Y₂O₃ exceeds 8%, there is a concern that the liquidus temperature increases and the refractive index decreases. The content of Y₂O₃ is preferably 7% or less and further preferably 6.5% or less.

The content of the rare-earth components is important for determining the properties of the present glass. Namely, with regard to the content of the rare-earth components calculated in terms of % by mol, for example, in the case where the present glass contains La₂O₃ and Y₂O₃, total content of La₂O₃ and Y₂O₃ (La₂O₃ +Y₂O₃) is preferably 18 to 21% by mol. When the total content is less than 18% by mol, it may become difficult to achieve both the high refractive index and high Abbe number. The total content is more preferably 18.5% by mol or more and further preferably 19% by mol or more. On the other hand, when the total content exceeds 21% by mol, vitrification may become difficult and there is a concern that the liquidus temperature increases. The total content is more preferably 20.8% by mol or less and further preferably 20.6% by mol or less.

Furthermore, the content of La₂O₃ in the rare-earth components calculated in terms of % by mol ((La₂O₃/total content of the rare-earth components), hereinafter referred to lanthanum ratio) is important for determining the properties of the present glass. With regard to the lanthanum ratio, for example, in the case where the present glass contains La₂O₃ and Y₂O₃, the molar % fraction (La₂O₃/(La₂O₃+Y₂O₃)) calculated by dividing the content of La₂O₃ by the total content of La₂O₃ and Y₂O₃ (La₂O₃+Y₂O₃) is preferably 0.67 to 0.92, more preferably 0.72 to 0.90, and further preferably 0.78 to 0.88. When the lanthanum ratio is lower than 0.67, thermal stability of the glass may decrease and the liquidus temperature may increase, which is hence not preferred. Also, when the lanthanum ratio is larger than 0.92, the viscosity of the glass molten liquid may decrease, which is hence not preferred.

For the purpose of preventing alteration of the glass surface upon press molding, the present glass does not substantially contain Li₂O. In the present Specification, the phrase “does not substantially contain (contains substantially no)” means that the component is not intentionally added, and the contamination as an inevitable impurity is not excluded. More specifically, the phrase means that the content of the component is at most 0.1%.

Also, the present glass does not substantially contain Gd₂O₃. Gd₂O₃ is a component which increases the refractive index, increases the Abbe number and improves the stability of the glass as in the case of La₂O₃ and Y₂O₃. However, Gd₂O₃ has a lower effect of increasing viscosity of the glass molten liquid than Y₂O₃ has, and when a large amount of Gd₂O₃ is introduced, the liquidus temperature becomes high, so that it becomes difficult to produce a preform having even shape and size and thus the productivity of the whole production process decreases.

In the present glass, Bi₂O₃ is not an essential component but may be present in a content of 0 to 5% for the purpose of increasing the refractive index. When the content exceeds 5%, there is a concern that transmittance remarkably decreases. In the case of increasing the Abbe number, Bi₂O₃ is preferably not substantially contained.

In the present glass, Yb₂O₃ is not essential components but may be present in a content of 0 to 10% for the purpose of increasing the refractive index, suppressing devitrification upon glass molding, or the like. When the content of Yb₂O₃ exceeds 10%, there is a concern that the glass becomes unstable and the glass molding temperature increases. Therefore, the content of Yb₂O₃ is preferably 5% or less and Yb₂O₃ is preferably not substantially contained.

In the present glass, Al₂O₃, Ga₂O₃ and GeO₂ are not essential components but at least one of them may be present in a content of 0 to 10% for the purpose of stabilizing the glass, adjusting the refractive index, or the like. When the content of any of Al₂O₃, Ga₂O₃, and GeO₂ exceeds 10%, there is a concern that the Abbe number becomes low. The content of any of Al₂O₃, Ga₂O₃, and GeO₂ is more preferably 8% or less and further preferably 6% or less. Also, since Ga₂O₃ and GeO₂ are extremely rare and expensive components, they are preferably not substantially contained from the viewpoint of production costs.

In the present glass, BaO, SrO, CaO, and MgO are not essential components but at least one of them may be present in a content of 0 to 5% for the purpose of stabilizing the glass, increasing the Abbe number, decreasing the press molding temperature, or the like. When the content of any of BaO, SrO, CaO, and MgO exceeds 5%, there is a concern that the refractive index becomes low.

In the present glass, optional components other than the above components can be selected depending on respective required properties. For example, in the case of putting importance on high refractive index and low glass transition temperature, the glass may contain SnO in a content of 0 to 4%.

Also, for the purpose of clarification and the like, the glass may contain Sb₂O₃. In that case, the content of Sb₂O₃ is preferably 0 to 1%, more preferably 0 to 0.5%, and further preferably 0 to 0.1%.

The present glass preferably substantially consists of the above components.

On the other hand, the present glass preferably does not substantially contain TeO₂. Although TeO₂ is a component which is effective for improving the refractive index, TeO₂ is a component which vigorously volatilizes and thus there is a concern that the glass composition becomes heterogeneous upon melting of the glass.

The present glass preferably does not substantially contain TiO₂. TiO₂ is a component which increases the refractive index and improves the stability of the glass but is a component which remarkably lowers the Abbe number.

The present glass preferably does not substantially contain Nb₂O₅. When the glass contains Nb₂O₅, there is a concern that the Abbe number decreases and the liquidus temperature increases.

Moreover, in the present glass, in order to reduce the environmental load, it is preferred that the glass does not substantially contain any of lead (PbO), arsenic (As₂O₃), thallium (Tl₂O), thorium (ThO₂), and cadmium (CdO). Further, when the glass contains fluorine, the thermal expansion coefficient of the glass tends to increase and it adversely affects the molding property, and also because the component is easily volatilized, the composition of the glass tends to be heterogeneous at the time of melting the glass. In addition, there is a problem that the durability of the mold is deteriorated upon press molding. Therefore, it is preferred that the present glass does not substantially contain fluorine either.

In the present glass, for the reasons of prevention of coloring and the like, it is preferred that the glass does not substantially contain transition metal compounds such as Fe₂O₃ as a representative. Even in the case where such compounds are inevitably incorporated by way of raw materials, it is preferred that the total content of the transition metal compounds in the present glass is limited to 0.01% or less.

As optical properties of the present glass, the refractive index is 1.86 to 1.90 and the Abbe number is 35 to 40. When the refractive index is 1.87 or more, the glass achieves miniaturization and thinning of lenses, which is hence preferred. The refractive index is further preferably 1.875 or more. On the other hand, when the refractive index exceeds 1.90, the Abbe number becomes small, which is hence not preferred from the viewpoint of providing a glass suitable in correction of chromatic aberration. The refractive index of the present glass is more preferably 1.89 or less and further preferably 1.885 or less.

For the purpose of lowering the dispersion property of the present glass, the Abbe number is more preferably 35.5 or more and further preferably 36 or more. Also, in order to enhance the stability of the glass, the Abbe number is more preferably 39 or less and further preferably 38 or less.

The glass transition temperature of the present glass is preferably 630° C. or lower. For the purpose of suppressing the deterioration of the mold upon press molding and preventing decrease in productivity, the glass transition temperature is preferably as low as possible. Therefore, the glass transition temperature of the present glass is more preferably 625° C. or lower and further preferably 620° C. or lower.

The yield point of the present glass is preferably 680° C. or lower. For the purpose of suppressing the deterioration of the mold upon press molding and preventing decrease in productivity, the yield point is preferably as low as possible. Therefore, the yield point of the present glass is more preferably 675° C. or lower and further preferably 670° C. or lower.

The liquidus temperature of the present glass is preferably 1,130° C. or lower for the purpose of forming a good preform. When the liquidus temperature exceeds 1,130° C., the glass tends to be devitrified upon preform molding and a carbon and heat-resistant alloy to be used as a receiving mold for the preform are deteriorated, which is hence not preferred. The liquidus temperature is preferably as low as possible, and is more preferably 1,120° C. or lower and further preferably 1,110° C. or lower. In this connection, in the present Specification, the liquidus temperature means a minimum temperature at which no crystals are generated from a glass molten liquid while holding the glass molten liquid at the temperature for 1 hour.

The preform for precision press molding of the present invention preferably contains the above optical glass.

As a method for producing the preform, a drop-formation method is preferred. In the drop-formation method, a glass molten liquid obtained by melting glass raw materials is stored in a tank and is allowed to flow out from a tip of a nozzle disposed on the tank to form a gob having a desired weight, and the gob is received on a mold while being floated with nitrogen gas to form a preform having an ellipsoidal, spherical or the like shape.

For the drop-formation method, the viscosity of the glass molten liquid at the liquidus temperature is preferably high. When the viscosity of the glass molten liquid is low, there is a concern that the gas for floatation enters inside of the glass and remains in the preform as bubbles. Namely, the viscosity of the glass molten liquid at the liquidus temperature is preferably 2.5 dPa·s or more and more preferably 2.8 dPa·s or more. On the other hand, when the viscosity of the glass molten liquid is too high, there is a concern that the flowing rate from the nozzle remarkably decreases, which is rather not preferred. Therefore, an upper limit of the viscosity of the glass molten liquid at the liquidus temperature is preferably 30 dPa·s and more preferably 20 dPa·s.

The optical element of the present invention preferably contains the present glass. Since the glass has the above-described optical properties, an optical design is easily performed when the glass is used as an optical element. As the optical element, an aspherical or spherical lens for use in digital cameras and the like may be mentioned. Since the optical element using the present glass does not substantially contain Li₂O, the element can provide products having a high quality where the lens surface is not altered.

As a method for producing the optical element, a press molding method is preferred from the viewpoint of enhancing mass productivity. In the press molding, a press molding mold in which the molding surface has been processed into a desired shape beforehand is employed. One pair of the molding molds are opposed above and below, the preform is placed therebetween, and both of the molding molds and the preform are heated to a temperature at which the viscosity of the glass is lowered to a viscosity suitable for molding the glass to soften the preform. Then, by molding it under pressure, the molding surfaces of the molding molds are precisely transferred to the glass.

An atmosphere upon press molding is preferably non-oxidizing atmosphere for the purpose of protecting the mold surface and the preform surface. As the non-oxidizing atmosphere, an inert gas such as argon or nitrogen, a reductive gas such as hydrogen, or a mixed gas of the inert gas and the reductive gas can be employed. Preferably, nitrogen gas or nitrogen gas containing a small quantity of hydrogen gas mixed therein can be used. Further, the pressure and time at pressurization can be appropriately changed depending on the viscosity of the glass or the like. After heating and pressurization, the molding molds and the press-molded article are cooled and, preferably at the time when the temperature reaches a temperature equal to or lower than the strain point, the article is released from the molds and taken out.

### EXAMPLES

The following will describe specific embodiments of the present invention, but the present invention is not limited thereto. Here, Examples 1 to 20 are Inventive Examples of the present invention and Examples 21 to 23 are Comparative Examples. Example 21 illustrates the glass composition described in Example 44 in Patent Document 1 cited in Background Art. Similarly, Example 22 illustrates Example 3 in Patent Document 2 and Example 23 illustrates Example 30 in Patent Document 3. The physical properties not described in the specification of the respective Patent Documents were measured for glasses, which were prepared by the methods described in Examples in the specification of the respective Patent Documents, by the methods to be mentioned below. Incidentally, values of each component, in terms of % by mol on the basis of oxides, are shown in Tables 5 to 8. Also, the total content of La₂O₃ and Y₂O₃ is abbreviated as La+Y in the tables and the absence of a measured value is represented by “-”. However, in the case of a composition containing Gd₂O₃, the value means the total content of La₂O₃, Gd₂O₃ and Y₂O₃, and is represented with attaching “*” to the value in the tables. Also, with regard to the lanthanum ratio in the tables, in the case of a composition containing Gd₂O₃, the ratio means a molar fraction La₂O₃/(La₂O₃+Gd₂O₃+Y₂O₃) of La₂O₃ to La₂O₃+Gd₂O₃+Y₂O₃ and is represented with attaching “*” to the value in the tables.

### [Raw Material Preparation Method]

The following raw materials were blended so as to obtain a glass having a composition shown in Tables 1 to 4, placed in a platinum crucible, and melted at about 1,250 to 1,350° C. for 1 to 1.5 hour, followed by clarification and stirring. After the resulting molten liquid was cast into a rectangular mold having a length of 100 mm and a width of 50 mm which was pre-heated at about 600 to 640° C., annealing was performed at a rate of about 1° C./minute to form a sample.

As the raw materials, H₃BO₃ was used in the case of B₂O₃. In the case of SiO₂, ZnO, WO₃, Ta₂O₅, ZrO₂, La₂O₃, and Y₂O₃, oxide raw materials thereof were used, respectively.

### [Evaluation Method]

With regard to the glass obtained, refractive index (n_{d}) at wavelength 587.6 nm (d line), refractive index (n_{C}) at wavelength 656.3 nm (C line), refractive index (n_{F}) at wavelength 486.1 nm (F line), Abbe number (v_{d}), glass transition temperature T_{g} (° C.), yield point At (° C.), and liquidus temperature T_{L} (° C.) were measured. The measurement methods thereof are described below.

Thermal characteristics (glass transition temperature, yield point): A sample processed into a cylindrical shape having a diameter of 5 mm and a length of 20 mm was measured at a heating rate of 5° C./minute by means of a thermometrical analysis apparatus (manufactured by Bruker AXS Company, trade name: TD5000SA).

Optical constants (refractive index, Abbe number): A sample processed into a rectangular shape having a side length of 20 mm and a thickness of 10 mm was measured by means of a precision refractometer (manufactured by Shimadzu Corporation, trade name: KPR-2000). The Abbe number was determined according to the equation for calculation: {(n_{d}−1)/(n_{F}−n_{C})}.

Liquidus temperature: A glass processed into a cubic shape having a side length of 10 mm was placed on a platinum dish and allowed to stand in an electric furnace set at a constant temperature for 1 hour. Then, the whole sample taken out was observed under an optical microscope (100 magnifications), and a minimum temperature where no precipitation of crystals was observed was taken as the liquidus temperature.

Viscosity η_{TL} at liquidus temperature: The viscosity was measured in accordance with JIS Standard Z8803:2011 (viscosity measurement method by means of a coaxial double cylindrical rotary viscometer). Specifically, a glass of 85 cm³ was placed in a platinum crucible having a diameter of 40 mm, a platinum-made rotor was submerged in the glass molten liquid, and a torque value was measured while the temperature was lowered from 1,350° C. to 900° C. at −60° C./hour, thereby determining the viscosity.

TABLE 1

| Composition/ | | | | | | |
|---|---|---|---|---|---|---|
| % by weight | Example 1 | Example 2 | Example 3 | Example 4 | Example 5 | Example 6 |
| B₂O₃ | 12.7 | 12.8 | 12.8 | 12.8 | 12.8 | 12.8 |
| La₂O₃ | 35.8 | 36.2 | 35.5 | 37.7 | 35.3 | 37.7 |
| SiO₂ | 2.9 | 3.0 | 3.0 | 2.9 | 2.9 | 3.0 |
| Li₂O | 0.0 | 0.0 | 0.0 | 0.0 | 0.0 | 0.0 |
| ZnO | 15.5 | 15.7 | 16.0 | 15.6 | 15.9 | 15.6 |
| WO₃ | 15.1 | 15.2 | 14.0 | 14.0 | 14.0 | 12.8 |
| Ta₂O₅ | 11.0 | 8.9 | 11.1 | 10.0 | 11.8 | 11.1 |
| ZrO₂ | 2.5 | 2.5 | 3.1 | 2.5 | 2.7 | 2.5 |
| Gd₂O₃ | 0.0 | 0.0 | 0.0 | 0.0 | 0.0 | 0.0 |
| Y₂O₃ | 4.5 | 5.7 | 4.5 | 4.5 | 4.5 | 4.5 |
| n_{d} | 1.88054 | 1.87781 | 1.87962 | 1.87961 | 1.87946 | 1.87941 |
| ν_{d} | 36.5 | 36.9 | 37.1 | 36.7 | 36.9 | 37.2 |
| T_{g}/° C. | 602 | 603 | 606 | 604 | 602 | 607 |
| Aₜ/° C. | 649 | 650 | 651 | 650 | 649 | 653 |
| T_{L}/° C. | 1100 | 1100 | 1100 | 1100 | 1100 | 1110 |
| η_{TL}/dPa · s | 2.8 | — | 2.8 | 2.8 | 2.8 | 2.8 |

TABLE 2

| Composition/ | | | | Example | Example | Example |
|---|---|---|---|---|---|---|
| % by weight | Example 7 | Example 8 | Example 9 | 10 | 11 | 12 |
| B₂O₃ | 12.5 | 12.8 | 11.0 | 11.6 | 11.1 | 11.6 |
| La₂O₃ | 37.0 | 35.8 | 35.8 | 35.8 | 36.8 | 37.2 |
| SiO₂ | 3.0 | 2.6 | 4.5 | 3.8 | 4.3 | 3.7 |
| Li₂O | 0.0 | 0.0 | 0.0 | 0.0 | 0.0 | 0.0 |
| ZnO | 17.8 | 18.2 | 18.0 | 18.5 | 18.0 | 17.9 |
| WO₃ | 12.4 | 12.3 | 12.3 | 12.2 | 12.1 | 11.7 |
| Ta₂O₅ | 10.4 | 10.3 | 10.9 | 10.2 | 10.1 | 10.6 |
| ZrO₂ | 3.1 | 3.1 | 2.8 | 3.1 | 3.0 | 2.8 |
| Gd₂O₃ | 0.0 | 0.0 | 0.0 | 0.0 | 0.0 | 0.0 |
| Y₂O₃ | 3.8 | 4.9 | 4.8 | 4.9 | 4.6 | 4.5 |
| n_{d} | 1.87968 | 1.87980 | 1.88004 | 1.88050 | 1.88074 | 1.88067 |
| ν_{d} | 36.8 | 37.2 | 37.1 | 37.0 | 37.1 | 37.1 |
| T_{g}/° C. | 600 | 600 | 608 | 605 | 608 | 607 |
| Aₜ/° C. | 647 | 647 | 656 | 652 | 657 | 653 |
| T_{L}/° C. | 1100 | 1100 | 1110 | 1110 | 1110 | 1110 |
| η_{TL}/dPa · s | — | — | 3.1 | 2.8 | — | — |

TABLE 3

| Composition/ | Example | Example | Example | Example | Example | Example |
|---|---|---|---|---|---|---|
| % by weight | 13 | 14 | 15 | 16 | 17 | 18 |
| B₂O₃ | 11.1 | 11.0 | 11.2 | 11.2 | 11.2 | 11.1 |
| La₂O₃ | 37.5 | 34.5 | 36.6 | 36.2 | 35.8 | 36.5 |
| SiO₂ | 4.3 | 4.3 | 4.3 | 4.2 | 4.2 | 4.3 |
| Li₂O | 0.0 | 0.0 | 0.0 | 0.0 | 0.0 | 0.0 |
| ZnO | 18.0 | 18.2 | 17.8 | 18.0 | 17.8 | 18.1 |
| WO₃ | 11.6 | 11.9 | 11.6 | 12.1 | 11.6 | 11.4 |
| Ta₂O₅ | 10.3 | 11.0 | 11.4 | 10.7 | 11.7 | 11.2 |
| ZrO₂ | 2.8 | 2.8 | 2.8 | 2.7 | 2.6 | 2.7 |
| Gd₂O₃ | 0.0 | 0.0 | 0.0 | 0.0 | 0.0 | 0.0 |
| Y₂O₃ | 4.3 | 6.4 | 4.3 | 4.8 | 5.1 | 4.7 |
| n_{d} | 1.88004 | 1.88112 | 1.88034 | 1.88066 | 1.88035 | 1.88019 |
| ν_{d} | 37.1 | 37.1 | 37.2 | 37.1 | 37.2 | 37.3 |
| T_{g}/° C. | 608 | 610 | 609 | 609 | 609 | 607 |
| Aₜ/° C. | 656 | 659 | 652 | 656 | 657 | 656 |
| T_{L}/° C. | 1110 | 1120 | 1110 | 1100 | 1110 | 1110 |
| η_{TL}/dPa · s | 3.1 | — | 3.0 | 3.4 | — | 3.1 |

TABLE 4

| Composition/ | Example | Example | Example | Example | Example |
|---|---|---|---|---|---|
| % by weight | 19 | 20 | 21 | 22 | 23 |
| B₂O₃ | 11.7 | 11.1 | 12.94 | 13.16 | 13.29 |
| La₂O₃ | 36.4 | 35.8 | 23.74 | 36.19 | 34.40 |
| SiO₂ | 3.7 | 4.3 | 3.62 | 6.63 | 3.02 |
| Li₂O | 0.0 | 0.0 | 0.0 | 0.0 | 0.0 |
| ZnO | 17.9 | 18.0 | 15.54 | 7.21 | 14.32 |
| WO₃ | 12.2 | 12.1 | 4.66 | 0.00 | 7.58 |
| Ta₂O₅ | 10.1 | 10.9 | 9.99 | 0.00 | 13.88 |
| ZrO₂ | 3.1 | 2.8 | 3.10 | 7.05 | 3.41 |
| Gd₂O₃ | 0.0 | 0.0 | 26.41 | 0.00 | 9.10 |
| Y₂O₃ | 4.9 | 4.9 | 0.00 | 0.00 | 0.00 |
| Nb₂O₅ | 0.0 | 0.0 | 0.00 | 3.85 | 0.00 |
| TiO₂ | 0.0 | 0.0 | 0.00 | 9.04 | 0.00 |
| BaO | 0.0 | 0.0 | 0.00 | 16.86 | 0.00 |
| n_{d} | 1.88057 | 1.88089 | 1.8638 | 1.87247 | 1.88169 |
| ν_{d} | 37.1 | 37.3 | 40.5 | 34.21 | 37.55 |
| T_{g}/° C. | 605 | 607 | 622 | 637 | 620 |
| Aₜ/° C. | 652 | 658 | 666 | 688 | 664 |
| T_{L}/° C. | 1110 | 1100 | 1230 | 1080 | 1120 |
| η_{TL}/dPa · s | 2.8 | 3.6 | 1.3 | — | 2.0 |

TABLE 5

| Composition/ | Exam- | Exam- | Exam- | Exam- | Exam- | Exam- |
|---|---|---|---|---|---|---|
| % by mol | ple 1 | ple 2 | ple 3 | ple 4 | ple 5 | ple 6 |
| B₂O₃ | 27.6 | 27.6 | 27.5 | 27.7 | 27.5 | 27.8 |
| La₂O₃ | 16.6 | 16.6 | 16.3 | 17.4 | 16.3 | 17.5 |
| SiO₂ | 7.4 | 7.4 | 7.4 | 7.4 | 7.4 | 7.4 |
| Li₂O | 0.0 | 0.0 | 0.0 | 0.0 | 0.0 | 0.0 |
| ZnO | 28.8 | 28.8 | 29.3 | 28.9 | 29.4 | 29.1 |
| WO₃ | 9.8 | 9.8 | 9.0 | 9.1 | 9.1 | 8.4 |
| Ta₂O₅ | 3.8 | 3.0 | 3.8 | 3.4 | 4.0 | 3.8 |
| ZrO₂ | 3.0 | 3.0 | 3.8 | 3.0 | 3.3 | 3.0 |
| Gd₂O₃ | 0.0 | 0.0 | 0.0 | 0.0 | 0.0 | 0.0 |
| Y₂O₃ | 3.0 | 3.8 | 3.0 | 3.0 | 3.0 | 3.0 |
| La + Y | 19.6 | 20.4 | 19.3 | 20.5 | 19.3 | 20.5 |
| Lanthanum | 0.85 | 0.81 | 0.84 | 0.85 | 0.84 | 0.85 |
| ratio | | | | | | |

TABLE 6

| Composition/ | Exam- | Exam- | Exam- | Exam- | Exam- | Exam- |
|---|---|---|---|---|---|---|
| % by mol | ple 7 | ple 8 | ple 9 | ple 10 | ple 11 | ple 12 |
| B₂O₃ | 26.4 | 26.9 | 23.0 | 24.2 | 23.3 | 24.6 |
| La₂O₃ | 16.7 | 16.1 | 16.0 | 16.0 | 16.5 | 16.8 |
| SiO₂ | 7.3 | 6.3 | 10.9 | 9.1 | 10.5 | 9.1 |
| Li₂O | 0.0 | 0.0 | 0.0 | 0.0 | 0.0 | 0.0 |
| ZnO | 32.1 | 32.6 | 32.3 | 33.0 | 32.3 | 32.3 |
| WO₃ | 7.9 | 7.8 | 7.7 | 7.6 | 7.6 | 7.4 |
| Ta₂O₅ | 3.4 | 3.4 | 3.6 | 3.3 | 3.3 | 3.5 |
| ZrO₂ | 3.7 | 3.7 | 3.4 | 3.7 | 3.5 | 3.4 |
| Gd₂O₃ | 0.0 | 0.0 | 0.0 | 0.0 | 0.0 | 0.0 |
| Y₂O₃ | 2.5 | 3.2 | 3.1 | 3.1 | 3.0 | 2.9 |
| La + Y | 19.2 | 19.3 | 19.1 | 19.1 | 19.5 | 19.7 |
| Lanthanum | 0.87 | 0.83 | 0.84 | 0.84 | 0.85 | 0.85 |
| ratio | | | | | | |

TABLE 7

| Composition/ | Exam- | Exam- | Exam- | Exam- | Exam- | Exam- |
|---|---|---|---|---|---|---|
| % by mol | ple 13 | ple 14 | ple 15 | ple 16 | ple 17 | ple 18 |
| B₂O₃ | 23.3 | 23.0 | 23.6 | 23.6 | 23.6 | 23.3 |
| La₂O₃ | 16.8 | 15.4 | 16.5 | 16.3 | 16.2 | 16.4 |
| SiO₂ | 10.5 | 10.5 | 10.5 | 10.1 | 10.3 | 10.5 |
| Li₂O | 0.0 | 0.0 | 0.0 | 0.0 | 0.0 | 0.0 |
| ZnO | 32.4 | 32.5 | 32.0 | 32.4 | 32.1 | 32.6 |
| WO₃ | 7.3 | 7.5 | 7.3 | 7.6 | 7.4 | 7.2 |
| Ta₂O₅ | 3.4 | 3.6 | 3.8 | 3.6 | 3.9 | 3.7 |
| ZrO₂ | 3.4 | 3.4 | 3.4 | 3.2 | 3.1 | 3.2 |
| Gd₂O₃ | 0.0 | 0.0 | 0.0 | 0.0 | 0.0 | 0.0 |
| Y₂O₃ | 2.8 | 4.1 | 2.8 | 3.1 | 3.3 | 3.0 |
| La + Y | 19.7 | 19.6 | 19.3 | 19.4 | 19.5 | 19.4 |
| Lanthanum | 0.86 | 0.79 | 0.85 | 0.84 | 0.83 | 0.84 |
| ratio | | | | | | |

TABLE 8

| Com- | | | | | |
|---|---|---|---|---|---|
| position/ | Example | Example | Example | Example | Example |
| % by mol | 19 | 20 | 21 | 22 | 23 |
| B₂O₃ | 24.5 | 23.3 | 28.57 | 23.81 | 29.27 |
| La₂O₃ | 16.4 | 16.1 | 11.20 | 13.99 | 16.19 |
| SiO₂ | 9.1 | 10.5 | 9.27 | 13.90 | 7.71 |
| Li₂O | 0.0 | 0.0 | 0.00 | 0.00 | 0.00 |
| ZnO | 32.2 | 32.4 | 29.34 | 11.16 | 26.98 |
| WO₃ | 7.7 | 7.6 | 3.09 | 0.00 | 5.01 |
| Ta₂O₅ | 3.4 | 3.6 | 3.47 | 0.00 | 4.82 |
| ZrO₂ | 3.7 | 3.4 | 3.86 | 7.21 | 4.24 |
| Gd₂O₃ | 0.0 | 0.0 | 11.20 | 0.00 | 3.85 |
| Y₂O₃ | 3.1 | 3.2 | 0.00 | 0.00 | 0.00 |
| Nb₂O₅ | 0.0 | 0.0 | 0.00 | 1.82 | 0.00 |
| TiO₂ | 0.0 | 0.0 | 0.00 | 14.26 | 0.00 |
| BaO | 0.0 | 0.0 | 0.00 | 13.85 | 0.00 |
| La + Y | 19.5 | 19.3 | *22.40 | 13.99 | *20.04 |
| Lanthanum | 0.84 | 0.83 | *0.50 | 1.00 | *0.81 |
| ratio | | | | | |

While the present invention has been described in detail with reference to the specific embodiments thereof, it will be apparent to one skilled in the art that various changes and modifications can be made therein without departing from the spirit and scope of the present invention.

The present application is based on the Japanese Patent Application No. 2012-045362 filed on Mar. 1, 2012, and the entire contents thereof are incorporated herein by reference. All references cited herein are incorporated in their entirety.

### INDUSTRIAL APPLICABILITY

An optical glass suitable for an optical element for use in an optical system of digital cameras and the like can be provided.

What is claimed is:

1. An optical glass comprising, in terms of % by weight on the basis of oxides,
B₂O₃: 8 to 15%,
La₂O₃: 27 to 40%,
SiO₂: 1 to 10%,
ZnO: 13 to 20%,
WO₃: 9 to 17%,
Ta₂O₅: 7 to 15%,
ZrO₂: 1 to 6%,
Y₂O₃: 2 to 8%, and
Bi₂O₃: 0 to 5%,
wherein the optical glass comprises substantially no Li₂O and Gd₂O₃ and
wherein the optical glass has a refractive index n_{d} of 1.86 to 1.90 and an Abbe number v_{d} of 35 to 40.

2. The optical glass according to claim 1, which has a liquidus temperature T_{L} of 1,130° C. or lower.

3. The optical glass according to claim 1, which further comprises, in terms of % by weight on the basis of oxides,
Yb₂O₃: 0 to 10%,
at least one selected from the group consisting of Al₂O₃, Ga₂O₃, and GeO₂: 0 to 10%, and
at least one selected from the group consisting of BaO, SrO, CaO, and MgO: 0 to 5%.

4. The optical glass according to claim 1,
wherein a total content (La₂O₃+Y₂O₃) of the La₂O₃ and the Y₂O₃ is 18 to 21% by mol, and a molar % fraction (La₂O₃/(La₂O₃+Y₂O₃)) of a content of the La₂O₃ to said total content is 0.67 to 0.92.

5. A preform for precision press molding, comprising the optical glass described in claim 1.

6. An optical element obtained by subjecting the preform described in claim 5 to a precision press molding.
